(19) United States
(12) Patent Application Publication
(10) Pub. No.: US 2008/0141124 A1
(43) Pub. Date: Jun. 12, 2008

(54) Methods, apparatus and systems for modifying and/or augmenting image displays in a graphical networked environment

(76) Inventor: Ovidiu Stavrica, Kenmore, WA (US)

Correspondence Address: GRAYBEAL, JACKSON, HALEY LLP, 155 - 108TH AVENUE NE, SUITE 350, BELLEVUE, WA, 98004-5973, US

(21) Appl. No.: 11/985,349

(22) Filed: Nov. 13, 2007

Related U.S. Application Data
(60) Provisional application No. 60/858,912, filed on Nov. 13, 2006.

(51) Int. Cl. G06F 17/00

(52) U.S. Cl. 715/255

(57) ABSTRACT

Methods, apparatus and systems to modify and/or augment requested data file(s) encoding, directly or through a hyperlink, at least one graphic (static or motion) image (collectively “web page(s)”). Modifications of a web page according to embodiments of the invention include identifying and replacing unsolicited advertisements that are graphic/display based with a generic image or images, and/or text (“basic replacement mode”); identifying and replacing advertisements that are graphic/display based with similarly sized display content (“selective replacement mode”); and adding content to a requested web page (“selective addition mode”). Under revenue model embodiments of the invention, one, some or all display (image(s)) advertisement(s) associated with a requested web page can be modified before the viewer receives the requested web page (“revenue replacement mode”). In addition or in the alternative, revenue model embodiments of the invention can also include adding content to the requested web page (“revenue addition mode”).

### BACKGROUND OF THE INVENTION

One of the pillars upon which the Internet's popularity rests is the World Wide Web (“WWW” or “the web”); most web site-related businesses center on advertising-based revenue models. In particular, individuals of the public at large with access to the Internet use web browser applications to view particular web sites because those web sites contain media and information content which they want to see. Specialized Internet businesses that provide such content generate revenue by selling advertising space to third parties. This business and revenue generation model is well known in the industry, spawning many highly successful and widely recognized companies such as Yahoo! and Google.

In addition to content, another component considered desirable for exploiting the web is a firewall. Firewalls are intended to insulate a user's computer from the dangers inherently present on the Internet. Firewalls can be software implemented, hardware implemented or a combination of the two (often embodied in a dedicated piece of hardware located at the gateway to the Internet). These tools are designed to protect individual users as well as business network environments from a wide range of productivity, privacy and security threats by providing anti-virus, firewall, VPN and anti-spam functionality. While all-in-one firewalls are an effective means to increase business productivity via layered network security, a drawback to advanced security appliances is often hardware acquisition and software/firmware maintenance costs.

Certain firewall solutions scan web traffic for viruses using a web proxy service. As each requested file arrives at the proxy, it is analyzed for viruses before being passed on to the requesting web browser. The Sentry firewall solution from Wiresoft Net, Inc. includes a feature that allows the proxy software to further analyze web page documents and identify placeholders for online advertising such as graphics banners, text links, flash animations, and the like. When the proxy finds such a placeholder, it has the ability to remove such references (e.g., HREF links) and replace them with an empty GIF image. This action has the net effect of removing advertisements from the web pages being rendered by the requesting browser.

While decreasing the clutter associated with a viewed web page and removing unwanted images, some users have found the automatic removal of advertisements on web pages as a sign that the web site is broken or more distracting the advertisements in the first place. In other words, there are users who want to see web advertisements, and perceive those advertisements as being part of the Internet “surfing” experience.

### SUMMARY OF THE INVENTION

Under the conventional revenue model described above, viewers of web pages are beholden to the content provider's selections regarding information and display advertisements (collectively “content”): the user must view what the content provider and its advertising partners dictate, including the size, location and composition of any display advertisement. In this manner, revenue received by the content provider for embedded display advertisements are intended to at least offset the content provider's costs for assembling and delivering the content; in some business models, the advertising revenue exceeds production costs and forms perhaps the sole basis for enterprise income.

Embodiments of the invention include methods, apparatus and systems to modify and/or augment requested data files encoding, directly or through a hyperlink, at least one graphic (static or motion) image (collectively “web pages”) between a point of delivery from a content provided and receipt by the user's client browser. The precise location of the invention embodiments within the global communications network depends, in part, upon the intended purpose of its implementation. Viable locations include at a service provider's server facilities, at a gateway for a wide area network (“WAN”), at a gateway for a local area network (“LoAN”), at a firewall or proxy server in a WAN or LoAN environment, or on discrete computers operatively running the client browser software.

In view of the foregoing, embodiments of the invention may be optimized for two distinct computing environments, namely single computer of small area local networks (collectively “SANs”) and large area networks (collectively “LaANs”). These terms are used herein for reference purposes and are not intended to delimit the scope of the invention embodiments, restrict any applications thereof, or exclude one application from the other. Instead, these terms have been selected to exemplify a presumptive environment wherein certain features of invention embodiments may find particular utility or advantages over the prior art, as will be illustrated in more detail below.

It is generally accepted in SALNs that a significant point in frustration with respect to content relates to downloading elements of the content that are not specifically on point with the requested information (collectively “unsolicited advertisements”). Not only must the user visually filter out such content, but it often is included in any printout, which consumes additional user resources such as ink/toner and paper. In addition, if the user does not have broadband connectivity or data usage is metered (as might occur with cellular and/or GSM based data connections), the additional bandwidth consumed by such unsolicited advertisements, when embedded in a hyperlink form, can be anywhere from annoying to costly. Just as with commercials present in broadcast advertisements, the unsolicited advertisements in a displayed web page are rarely embraced and tolerated at best.

Embodiments of the invention that are optimized for SALNs provide means for identifying and replacing unsolicited advertisements that are graphic/display based with a generic image or images, and/or text (“basic replacement mode”). In this manner, the disadvantages associated with receiving, processing and displaying many such advertisements are removed: the content, which may be identified and/or selected by way of user defined filters, is simply removed, and replaced with one or more images and/or text. The images or text are preferable stored locally so as not to increase download time or bandwidth, and may be selected by the user and/or software provider, and/or service provider. Depending upon the nature of the requested web page, it can be reconstituted so as to mask the deletion of certain content (particularly when the web page is dynamically created), or the size parameters of the replaced content simply left in its original form.

As the skilled practitioner will appreciate, blocking requested content achieves a similar end result as deleting the same content; the graphical space originally intended to be occupied by the unsolicited advertisement has no content other than noted above. Thus, for example, the process of identification can take place as the code is being parsed by the web browser application and/or as the requested packets embodying the unsolicited advertisements are received, and/or as the page is being rendered.

While insulation from unsolicited advertisements can be a prime objective in SANs, prime objectives for LaANs can be, but are not necessarily, quite different. In some LaANs, for instance, the users are all related in some manner, such as by common employer (i.e., a corporate intranet or LAN). In these environments, there may be more concern for what is being viewed in as opposed to the fact that certain content is being viewed. For example, display advertisements for a corporation's competitor's goods and/or services may be considered objectionable. In this environment, removal of the offending content and replacement of the offending content with administrator derived content may constitute another solution. In these cases means may be provided in certain embodiments of the invention for identifying and replacing advertisements that are graphic/display based with similarly sized display content (“selective replacement mode”). In this manner, only certain forms of unsolicited advertisements are targeted for replacement, with the objective not being the substantial replacement of all such advertisements, but selective replacement with alternative content.

A feature of invention embodiments further provides for the addition of content to a requested web page, whether that page has been subject to content modification as described above or not. Particularly, where the web page is dynamically created, e.g., via ASP or similar rendering protocol, embodiments of the invention provide for adding content to the requested web page (“selective addition mode”). In this manner, the rendered page retains at least some of its original content, but is augmented by additional content not provided by the original content provider. This additional content may or may not be keyed or related to the display (image(s)) advertisement(s) either passed through or replaced from a displayed web page.

In the foregoing environments, the replacement of unsolicited advertisements was driven primarily by non-monetary concerns. However, it is recognized that just as content providers can and do generate revenue from advertisements, so can others downstream from the content provider. Under revenue model embodiments of the invention, one, some or all display (image(s)) advertisement(s) associated with a requested web page can be modified before the viewer receives the requested data encoding the page for which display is desired (“revenue replacement mode”). In addition or in the alternative, revenue model embodiments of the invention can also include adding content to the requested web page (“revenue addition mode”).

Various entities may exploit the revenue replacement and/or addition mode(s), and include service providers and providers of network/computer hardware such as hardware-based firewalls and/or proxy servers.

As noted earlier, the replacement and/or additional content provided by hardware/software embodiments of the invention may be dynamic, e.g., the content is administered by a remote server and delivered to the hardware/software embodiments based upon intrinsic (hardware/software embodiment internal rules and algorithms) and/or extrinsic (e.g., environmental factors, changes in advertiser accounts, etc.) criteria. In addition to, or alternatively, modification and/or augmentation content may be administered locally by the owner or administrator of the hardware/software embodiments of the invention.

A feature of certain embodiments of the invention concerns the ability to prevent the previously described modification and/or augmentation of a web page to take place. It is contemplated that original content providers, faced with the prospect that some of its viewers will not be subject to certain advertising media, will face negative financial repercussions from their advertisers: why would an advertiser pay a content provider a fee for an advertisement that will never reach the intended viewer? It is further contemplated that some content providers would restrict access to their content to only those viewers that do not “adulter” their content. This could be accomplished either by license (access is only granted if the requesting party is permitted to view, without adulteration, the content sent by the content provider) or attempting to invoke principles such as droit morale (although the inventor believes that because only commercial speech is involved, application of this legal theory is misplaced).

A problem exists in that it is very difficult to ascertain which viewer(s), especially behind a firewall or proxy, is/are modifying/augmenting advertising content. Thus, a click-through license would become cumbersome since it could not merely rely upon an IP address (if only one user behind such a firewall and/or proxy would refuse the license, then content delivery to all users associated with that IP address, e.g., gateway address) would be restricted. Because there is little in the way of reporting modification/augmentation actions to the content provider, enforcement of some form of copyright becomes nearly impossible

Thus, a more elegant method can be obtained by the content provider sending flag data to compliant hardware/software embodiments of the invention whereby the flag data would establish modification/augmentation permissions for one, some or all of the display (image) advertisements. In essence, the content provider could then be assured that its identified advertisements (as determined by the flag data) would not be adversely affected by implementation of the modification/augmentation features of the hardware/software embodiments of the invention. A related aspect of this invention embodiment then provides for compensation from the content provider to the administrator and/or owner of the hardware/software embodiments of the invention for this privilege. In essence, the administrator and/or owner of the hardware/software embodiments of the invention become the gatekeeper of content to the networked user, as opposed to the actual content provider.

A related feature is a reverse revenue implementation of the previous feature wherein the administrator and/or owner of the hardware/software embodiments of the invention offsets the content provider's potential loss of advertising revenue with compensation in return for unrestricted access to the content provided thereby. Referring to the license option referenced above, the administrator and/or owner could ensure uninterrupted access to certain content, and have the ability to modify/augment the display (image) advertisements, upon payment of compensation to the content provider. Flag data, issued by the hardware/software embodiments of the invention, would alert to the content provider of the requesting entity and bypass normal click-through licensing requirements.

What is claimed:

1. A method of for replacing selective content in a user requested web page originating from a content provider comprising:
receiving a data stream encoding the requested web page;
identifying at least one embedded graphic element or hyperlink to a graphic element;
replacing the at least one graphic element with a graphic element not originating from the content provider of source of the hyperlinked graphic element; and
permitting the user to receive the modified requested web page.

2. A method of for augmenting content in a user requested web page originating from a content provider comprising:
receiving a data stream encoding the requested web page;
modifying the data encoding the requested page to include at least one additional graphic element not originating from the content provider; and
permitting the user to receive the augmented requested web page.
